(19) United States
(12) Patent Application Publication
(10) Pub. No.: US 2005/0057441 A1
(43) Pub. Date: Mar. 17, 2005

(54) Three dimensional stereoscopic image display apparatus

(76) Inventor: In-Kyu Park, Kyunggi-do (KR)

Correspondence Address: McDermott Will & Emery, 600 13th Street NW, Washington, DC, 20005-3096, US

(21) Appl. No.: 10/490,052

(22) PCT Filed: Jul. 16, 2003
(86) PCT No.: PCT/KR03/01415

(30) Foreign Application Priority Data
Jul. 19, 2002 (KR) 10-2002-0042698

(51) Int. Cl. G09G 5/00

(52) U.S. Cl. 345/9

(57) ABSTRACT

The present invention is to provide a three dimensional stereoscopic image display apparatus that comprises an image display panel portion in which a plurality of left eye image pixels and a plurality of right eye image pixels are alternately disposed; a first polarizing plate disposed in front of the image display panel portion; and a second polarizing plate disposed in front of the first polarizing plate, wherein the first polarizing plate comprises a plurality of first left eye image polarizers which correspond to the plurality of the left eye image pixels and a plurality of first right eye image polarizers which correspond to the plurality of the right eye image pixels, and wherein the second polarizing plate comprises a second left eye image polarizing portion and a second right eye image polarizing portion.

### FIELD OF THE INVENTION

The present invention relates to a three dimensional stereoscopic image display apparatus, and more particularly, to a three dimensional stereoscopic image display apparatus using polarizing plates.

### BACKGROUND OF THE INVENTION

The first stereoscopic display technology was introduced by Charles Wheatstone in 1836 in England. Along with the development in photography technology, the stereoscopic image technologies using the parallax barrier and the lenticular lens have been improved rapidly in 20th century. A new concept of three dimensional image display, that is, hologram technology, was also invented in the middle of the century. Recently, many other approaches have been used for the three dimensional image display, such as anaglyph, polarizer goggles, shutter-glasses, and head-mount set for virtual reality. Each technology has its own benefits and problems at the same time.

The hologram technology has not yet directly applicable to the current digital image technology of which resolution is much crude. The methods with glasses such as anaglyph, polarizer glasses, that ism shutter-glasses have been not generally well received in the arts because of inconvenience, and some potential health problems (dizziness, vomiting, etc).

Therefore, the stereoscopic display technology which does not need any special glasses, so called auto-stereoscopy, has been a hot topic in the arts. There are two well-known technologies available for the auto-stereoscopy: lenticular lens method and parallax barrier method. The lenticular method uses an array of multiple cylindrical lenses in front of the image display panel. The parallax barrier method uses an array of multiple dark stripes in front of the image display panel.

Recently, these methods have been popular thanks to the TFT-LCD (Thin Film Transistor—Liquid Crystal Display) technology. Many parallax barrier types of 3D stereoscopic image display apparatus combined with the TFT LCD technology has been proposed.

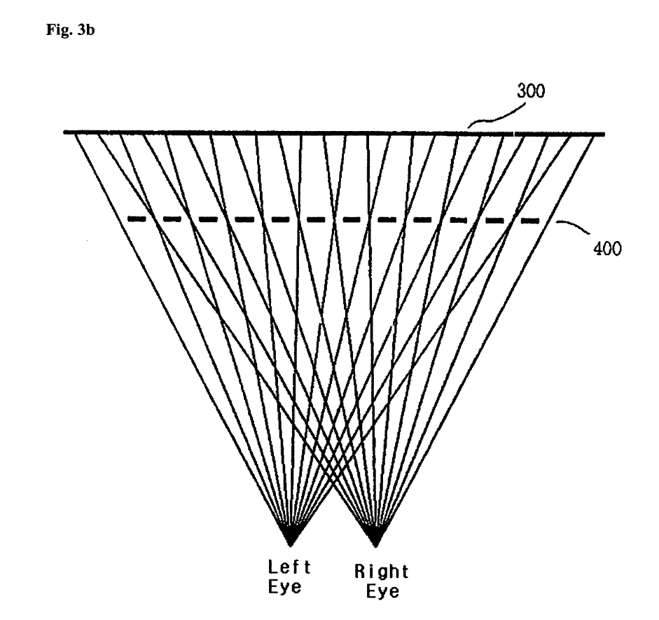

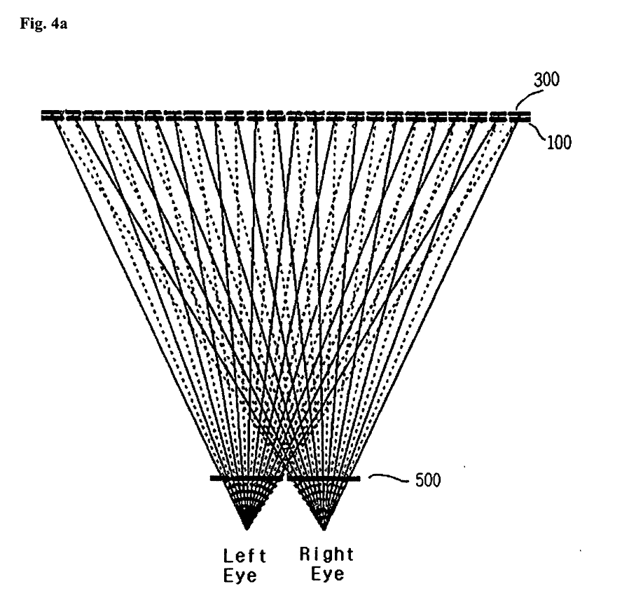

Now, the conventional parallax barrier type of 3D stereoscopic image display apparatus will be explained in order to understand the present invention. FIGS. 3a and 3b are view illustrating constructions of the conventional parallax barrier type of a 3D stereoscopic image display apparatus. As shown in FIGS. 3a and 3b, the parallax barriers 400 comprising multiple parallel dark bars are disposed in front of the image display panel 300. The parallax barriers 400 which are dark bars shield or block the light beams from left (right) images which enters right eye. The dotted lines denote the shielded light beams. The slits between the parallax barriers, that is, the space between barriers, guide or pass the light beams for the left right eyes to see the left and right eye images, respectively. The solid lines denote the passed light beams. Therefore, a viewer will perceive only part of images on the image display panel 300 due to the parallax barriers 400. FIG. 3b shows only the viewable light beams. Hence, the viewer's left eye can only see the left eye images, while his right eye see the right eye image only. The viewer will see a 3D effect due to binocular vision. This method is simple and can be implemented easily even with file mask.

Benefit of the parallax barrier method is the fact that it does not require any special glasses.

However, a viewer can see three dimensional image only in a specific zone, as drawn in the figures, and can not see the three dimensional image if the viewer is out of the viewer zone.

Another problem is the fact that the resolution of the image becomes half (half for left eye image, and another half for right eye image).

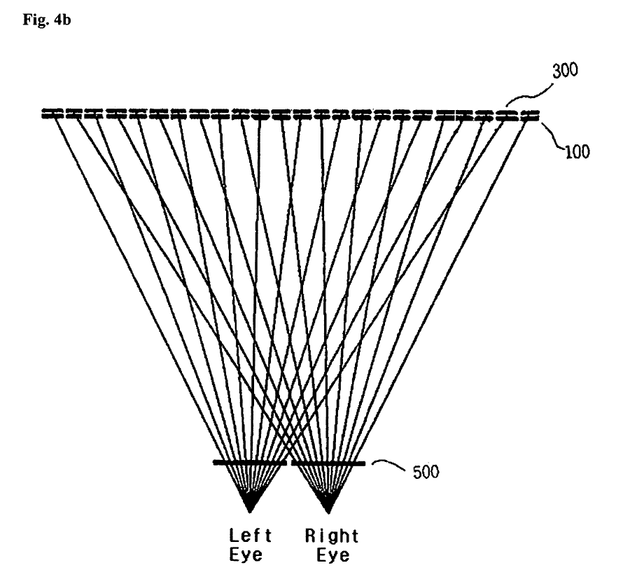

Now, a conventional method using polarizing glasses will be described. FIGS. 4a and 4b are schematic diagrams illustrating a conventional three dimensional image display with polarizing glasses. As shown in FIG. 4a, an array of polarizer panel 100 is placed in front of the image display panel 300, where polarizers with −45 degree angle are placed on the left eye images while −45 degree polarizers are on the right eye images. The viewer wears a pair of polarizer glasses 500, where lens for left eye has its polarization angle of 45 degree and lens for right eye has its polarization angle of −45 degree. In FIG. 4a, solid lines represent viewable light beams which are passed through the polarizing filters (lenses), while dotted lines represent the blocked light beams due to polarizer setup. Therefore, the viewer can only see the light beams shown in the FIG. 4b, and see the three dimensional image due to the binocular vision.

Benefit of the polarizer glasses method is the fact that the viewer can see three dimensional image in any place in front of the display.

However, wearing such glasses result some inconvenience for the viewer. Following some ergonomical issues, problems with dizziness or vomiting were reported.

Another crucial inconvenience is that the viewer has to put on and off the glasses when he wants to see two dimensional images and three dimensional images together.

### SUMMARY OF THE INVENTION

The object of the present invention is to solve the above problems in the convention technique.

An aspect of the present invention is to provide a three dimensional stereoscopic image display apparatus that comprises an image display panel portion in which a plurality of left eye image pixels and a plurality of right eye image pixels are alternately disposed; a first polarizing plate disposed in front of the image display panel portion; and a second polarizing plate disposed in front of the first polarizing plate, wherein the first polarizing plate comprises a plurality of first left eye image polarizers which correspond to the plurality of the left eye image pixels and a plurality of first right eye image polarizers which correspond to the plurality of the right eye image pixels, and wherein the second polarizing plate comprises a second left eye image polarizing portion and a second right eye image polarizing portion.

In the three dimensional stereoscopic image display apparatus according to the present invention, it is preferable that the second left eye image polarizing element comprises a second left eye image transparent polarizer for passing light directed from the first left eye image polarizers to the left eye; and a second left eye image shielding polarizer for shielding light directed from the first left eye image polarizers to the right eye, and wherein the second right eye image polarizing portion comprises a second right eye image shielding polarizer for shielding light directed from the first right eye image polarizers to the left eye; and a second right eye image transparent polarizer for passing light directed from the first right eye image polarizers to the right eye.

In the three dimensional stereoscopic image display apparatus according to the present invention, it is preferable that the first left eye image polarizer and the second left eye image polarizing element have a first polarization angle, the first right eye image polarizer and the second right eye image polarizing portion have a second polarization angle, and the phase difference between the first and second polarization angles is 90 degree.

In the three dimensional stereoscopic image display apparatus according to the present invention, it is preferable that the first left eye image polarizer, the second left eye image transparent polarizer, and the second right eye image shielding polarizer has a first polarization angle, the first right eye image polarizer, the second left eye image shielding polarizer, and the second right eye transparent polarizer has a second polarization angle, and the phase difference between the first and second polarization angles is 90 degree.

In the three dimensional stereoscopic image display apparatus according to the present invention, it is preferable that the first polarization angle is 45 degree, and the first polarization angle is −45 degree.

In the three dimensional stereoscopic image display apparatus according to the present invention, it is preferable that the first polarizing plate and the second polarizing plat angle is able to be changed between an active state and an inactive state.

In the three dimensional stereoscopic image display apparatus according to the present invention, it is preferable that the second polarizing plate is formed with a twisted nematic (TN) liquid crystal device.

In the three dimensional stereoscopic image display apparatus according to the present invention, it is preferable that the image display panel portion is constructed with a liquid crystal display panel.

In the three dimensional stereoscopic image display apparatus according to the present invention, it is preferable that the image display panel portion is constructed with a plasma display panel.

### BRIEF DESCRIPTION OF THE DRAWINS

The above and other objects, advantages and features of the present invention will become apparent from the following description of preferred embodiments given in conjunction with the accompanying drawings, in which:

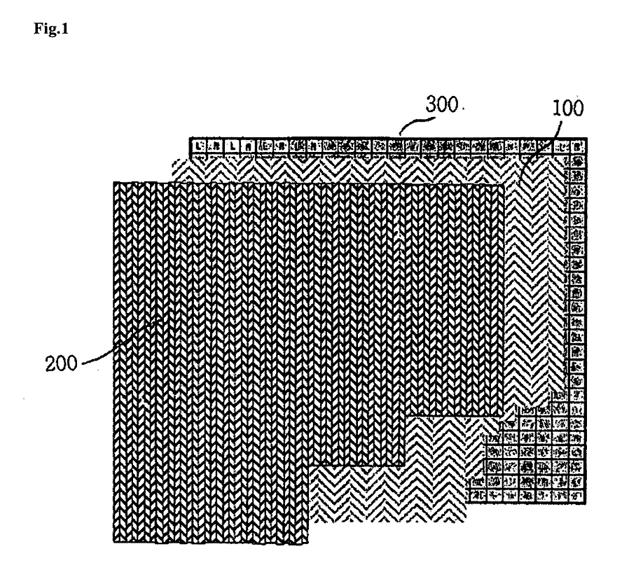

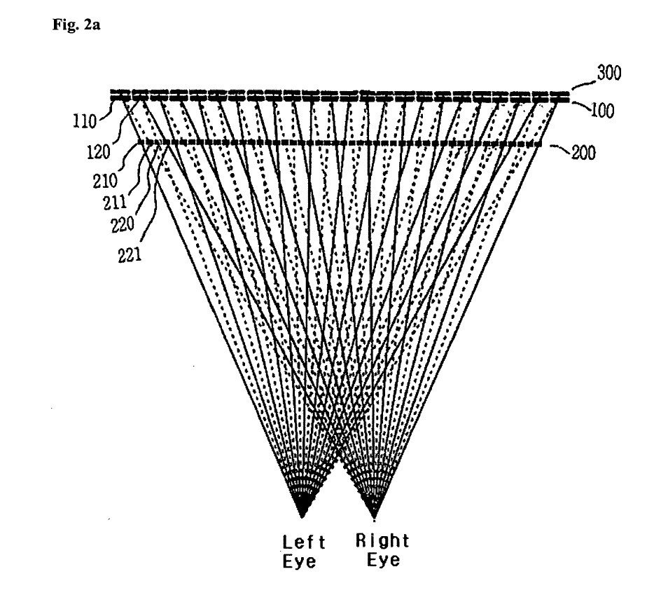

FIG. 1 is a perspective view illustrating a three dimensional stereoscopic image display apparatus according to the present invention;

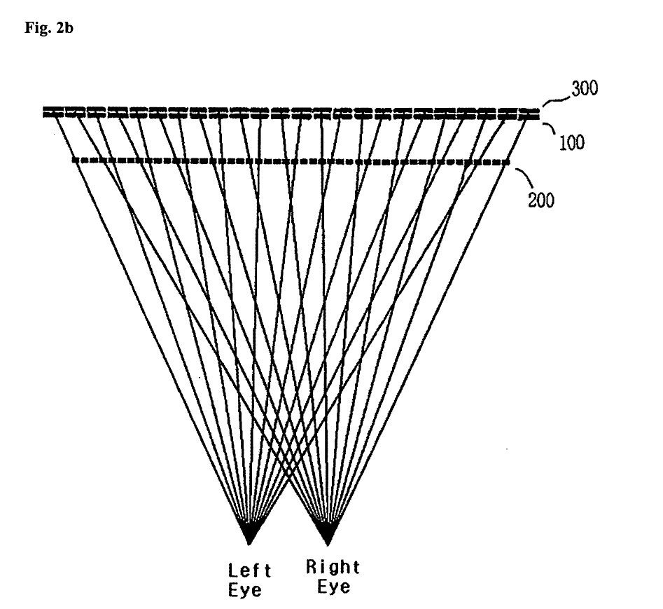

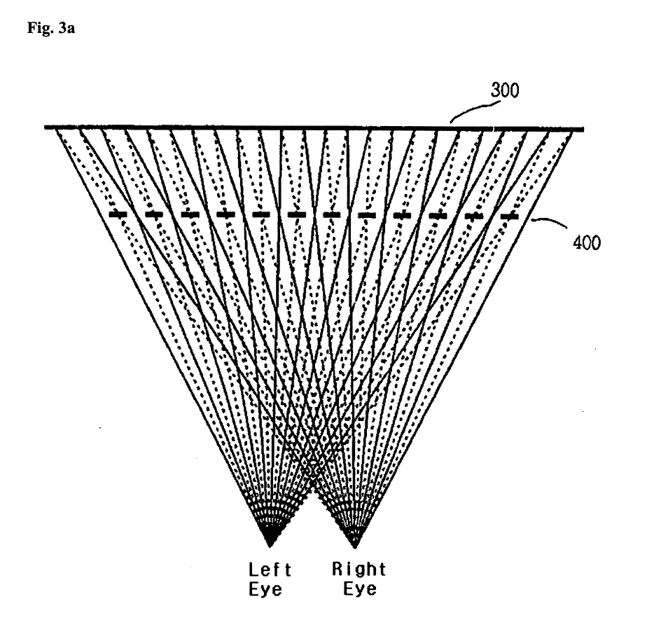

FIG. 2a is a schematic diagram for explaining operations of a first polarizing plate and a second polarizing plate in the three dimensional stereoscopic image display apparatus of the present invention shown in FIG. 1;

FIG. 2b is a schematic diagram for explaining operations of a first polarizing plate and a second polarizing plate in the three dimensional stereoscopic image display apparatus of the present invention shown in FIG. 1;

FIG. 3a is a view illustrating a conventional parallax barrier stereoscopic image display apparatus;

FIG. 3b is a view illustrating a conventional parallax barrier stereoscopic image display apparatus;

FIG. 4a is a view for explaining the principle of a conventional polarizing goggle stereoscopic image display apparatus; and

FIG. 4b is a view for explaining the principle of a conventional polarizing goggle stereoscopic image display apparatus.

### DETAILED DESCRIPTION OF THE PREFERRED EMBODIMENTS

Now, the preferred embodiments according to the present invention will be described in details with reference to the accompanying drawings.

[First Embodiment]

FIG. 1 is a view illustrating an embodiment of the present invention. As shown in FIG. 1, the three dimensional stereoscopic image display apparatus according to an embodiment of the present invention comprises an image display panel portion 300, a first polarizing plate 100 disposed in front of the image display panel portion 300, and a second polarizing plate 200 disposed in front of the first polarizing plate 100.

In the image display panel portion 300, a plurality of left eye image pixels L and a plurality of right eye image pixels R are alternately disposed. One image which is formed by the left eye image pixels L is perceived with the left eye, and the other image which is formed by the right eye image pixels R is perceived with the right eye. The image display panel portion 300 is constructed with, for example, a liquid crystal display panel. In another embodiment of the present invention, the image display panel portion 300 may be constructed with a plasma display panel, an organic electroluminescence (EL) display panel, or a CRT display apparatus.

In the image display panel portion 300, the left eye image pixels L and the right eye image pixels R are disposed in a shape of a matrix. In other words, the left eye image pixels L and the right eye image pixels R are disposed alternately in the horizontal direction. In the vertical direction, the same type of image pixels are aligned so that the left and right eye image pixels L, R can be alternately formed in two types of strips.

FIG. 2a is a schematic diagram for explaining operations of a first polarizing plate and a second polarizing plate in the three dimensional stereoscopic image display apparatus of the present invention shown in FIG. 1. In FIG. 2a, solid lines denote the light beams which reach the left and right eyes by operations of the first and second polarizing plates 100, 200. Dotted lines denote the light beans which are not able to reach the left and right eyes by other operations of the first and second polarizing plates 100, 200. These operations of the first and second polarizing plates are described later.

Referring to FIG. 2a, the first polarizing plate 100 which is disposed in front of the image display panel portion 300 comprises a plurality of first left eye image polarizers 110 and a plurality of first right eye image polarizers 120. The plurality of the first left eye image polarizers 110 and the plurality of the first right eye image polarizers 120 are disposed corresponding to the left eye image pixels L and the right eye image pixels R, respectively. The number of the first left eye image polarizers 110 is identical to that of the left eye image pixels L, and the number of the first right eye image polarizers 120 is identical to that of the right eye image pixels R.

The first left eye image polarizers 110 polarizes the light beams which are emitted from the left eye image pixels L into light beams with a predetermined polarization angle. The first right eye image polarizers 120 polarizes the light beams which are emitted from the right eye image pixels R into light beams with a predetermined polarization angle having phase difference of 90 degree with the polarization angle of the first left eye image polarizers 110. Preferably, in the embodiment of the present invention, the polarization angle of the first left eye image polarizers 110 is 45 degree and the polarization angle of the first right eye image polarizers 110 is −45 degree. However, any polarization angles may be selected if the difference between the first left eye image polarizers 110 and the first right eye image polarizers 120 is 90 degree. Therefore, the present invention is not limited to the aforementioned specific angles.

On the other hand, it is preferable that the first polarizing plate 100 is appropriately close to he the image display panel portion 300 so that the light beams emitted form the left eye image pixels L may not enter the first left eye image polarizers 110 and the light beams emitted from the left eye image pixels L may not enter the first right eye image polarizers 120. By doing so, the separation of the left and right eye images is ensured, so that an viewer may perceive the stereoscopic image accurately.

The 45 degree polarized light beam from the first left eye image polarizers 110 of the first polarizing plate and the −45 degree polarized light beams from the first right eye image polarizers 120 of the first polarizing plate are incident on the second polarizing plate 200. The second polarizing plate 200 has functions of passing or shielding the light beams.

The second polarizing plate 200 comprises second left eye image polarzing elements and second right eye image polarizing elements. The second left eye image polarzing elements pass or shield the light beams emitted from the left eye image pixels L. Similarly, the second right eye image polarzing elements pass or shield the light beams emitted from the right eye image pixels L. The number of the second left eye image polarzing elements is identical to that of the first left eye image polarizers 110 and the second right eye image polarizing elements is identical to that of the first right eye image polarizers 120.

Furthermore, each of the second left eye image polarzing elements comprises a second left eye image transparent polarizer 210 and a second right eye image shielding polarizer 211. Similarly, each of the second right eye image polarzing elements comprises a second right eye image transparent polarizer 220 and a second right eye image shielding polarizer 221.

As shown in FIG. 2a, each of the second left eye image polarzing elements comprises two polarizers 210, 211 which pass or shield the light beam emitted from the first left eye image polarizers 100 from the first polarizing plate 100.

The second left eye image transparent polarizer 210 has a function of passing the light beam emitted from the first left eye image polarizers 110 to the left eye so that the left eye image can reach the left eye of the viewer. The polarization angle of the second left eye image transparent polarizer 210 is the same as that of the first left eye image polarizer in order to pass the light beam emitted from the first left eye image polarizer. As described above, since the polarization angle of the first polarizing plate is 45 degree in the embodiment, The polarization angle of the second left eye image transparent polarizer 210 is 45 degree.

The second left eye image shielding polarizer 211 has a function of shielding the light beam emitted from the first left eye image polarizers 110 to the right eye so that the left eye image can not enter the right eye. The polarization angle of the second left eye image shielding polarizer 211 has the phase difference of 90 degree to that of the first left eye image polarizer in order to shield the light beam emitted from the first left eye image polarizer to the right eye. Therefore, the polarization angle of the second left eye image shielding polarizer 211 is −45 degree in the embodiment.

As shown in FIG. 2b, each of the second right eye image polarzing elements comprises two polarizers 220, 221 which pass or shield the light beam emitted from the first right eye image polarizers 120 from the first polarizing plate 100.

The second right eye image shielding polarizer 220 has a function of shielding the light beam emitted from the first right eye image polarizers 120 to the left eye so that the right eye image can not enter the left eye. The polarization angle of the second right eye image shielding polarizer 220 has the phase difference of 90 degree to that of the first right eye image polarizer in order to shield the light beam emitted from the first right eye image polarizer to the left eye. Therefore, the polarization angle of the second right eye image shielding polarizer 220 is 45 degree in the embodiment.

The second right eye image transparent polarizer 221 has a function of passing the light beam emitted from the first right eye image polarizers 120 to the right eye so that the right eye image can reach the right eye of the viewer. The polarization angle of the second right eye image transparent polarizer 210 is the same as that of the first right eye image polarizer in order to pass the light beam emitted from the first right eye image polarizer. Therefore, the polarization angle of the second right eye image transparent polarizer 221 is −45 degree.

In the second polarizing plate 200, the positions of the second left eye image transparent polarizer 210, the second left eye image shielding polarizer 211, the second right eye image shielding polarizer 220 and the second right eye image transparent polarizer 221 and their spacing may be varied in accordance with the design of the apparatus without departing from the principle of the present invention.

Referring to FIG. 2a, the polarizers are disposed in the sequence of the second left eye image transparent polarizer 210, the second left eye image shielding polarizer 211, the second right eye image shielding polarizer 220 and the second right eye image transparent polarizer as a one set. However, the present invention is not limited to the sequence. If the polarizers are disposed at positions which are located toward the viewer from the intersection near the pixels In FIG. 2a, the set of four polarizers may be disposed in the other sequence of the second left eye image transparent polarizer 210, the second right eye image shielding polarizer 220, the second left eye image shielding polarizer 211, and the second right eye image transparent polarizer. Even in the modified arrangement, it is possible to obtain the effects of the present invention.

According to the embodiment, the separation of the left and right eye images in the image display panel portion is ensured, so that an viewer may perceive the stereoscopic image accurately.

In addition, according to the present invention, the change between three dimensional (3D) image display and two dimensional (2D) image display can be performed. In the conventional apparatus, the change between 3D and two dimensional image display is difficult. For example, in a goggle type apparatus, goggles have to be taken off in order to perceive the two dimensional image.

The apparatus according to the present invention is applicable to a stereoscopic display device which displays the three dimensional image and the two dimensional image at the same time on the same screen.

According to the present invention, it is possible to solve the problems that the resolution is reduced in half in the conventional parallax barrier type apparatus.

According to the present invention, it is possible to avoid the viewer's dizziness or vomiting that are the problems of the polarizer glasses methods.

[Second Embodiment]

In the second embodiment of the present invention, the aforementioned construction of the three dimensional stereoscopic image display apparatus of the first embodiment is incorporated, and particularly, the first polarizing plate and the second polarizing plate are constructed to be changed between an active state and an inactive state.

Here, the inactive state of the polarizing plate is that the polarizing plate does not polarize the light beams and the active state of the polarizing plate is that the polarizing plate polarizes the light beams.

The apparatus with the polarizing plates that are able to be changed between the active and inactive states according to the second embodiment of the present invention improves the applicability of the three dimensional stereoscopic image display apparatus.

Firstly, in a mode that the first polarizing plate is in the active state and the second polarizing plate is in the inactive state, the associated construction is identical to that of the first embodiment as described above. Therefore, the description on the apparatus in this mode is omitted.

Next, in a mode that both of the first and second polarizing plates are in the inactive states and the left eye image pixels or the right eye image pixels are selectively activated, the viewer perceives not the three dimensional stereoscopic image but the two dimensional image. In the mode capable of displaying two dimensional image, the work for document is suitable. According to the second embodiment, it is possible to display the three dimensional image and the two dimensional image selectively.

Next, in a mode that the first polarizing plates are in the active state and the second polarizing plate are in the inactive state, the same image as the conventional polarizing glasses method can be obtained. In the mode, the viewer can perceive the stereoscopic image with glasses. Even though the polarizing glasses methods have some problems such as dizziness, the methods have that unique advantage that the stereoscopic image can be seen at any viewing direction. In this mode, it is possible to obtain the same advantage as the polarizing glasses methods.

According to the second embodiment of the present invention, it is possible to obtain the same advantages as those of the parallax barrier type and the polarizing glasses method by selecting the aforementioned modes.

### INDUSTRIAL APPLICALBILTY

According to the three dimensional stereoscopic image display apparatus of the present invention, it is possible to solve the problems that the resolution is reduced in half in the conventional parallax barrier type apparatus.

According to the three dimensional stereoscopic image display apparatus of the present invention, it is possible to obtain the same advantages as those of the parallax barrier type and the polarizing glasses method by selecting or changing the modes.

According to the three dimensional stereoscopic image display apparatus of the present invention, it is possible to obtain the same advantages as those of the parallax barrier type and the polarizing glasses method by selecting or changing the modes

According to the three dimensional stereoscopic image display apparatus of the present invention, it is possible to avoid some inconvenience for the viewer due to putting on and off glasses in the conventional polarizing glasses method. In addition, it is possible to avoid the viewer's dizziness or vomiting in the polarizer glasses methods.

According to the three dimensional stereoscopic image display apparatus of the present invention, it is possible to display the three dimensional image and the two dimensional image at the same time on the same screen.

In the three dimensional stereoscopic image display apparatus of the present invention, it is preferable that the second polarizing plate is constructed with a twisted nematic liquid crystal display device, since the twisted nematic liquid crystal device is able to be changed between the aforementioned active and inactive states and has polarization. However, the present invention is not limited to the twisted nematic liquid crystal device.

In the three dimensional stereoscopic image display apparatus of the present invention, it is preferable that the image display panel portion is constructed with, for example, a liquid crystal display panel. However, the image display panel portion may be constructed with a plasma display panel, an organic electroluminescence (EL) display panel, or a CRT display apparatus without departing from the spirit and scope of the present invention.

Although the present invention and its advantages have been described in details, it should be understood that the present invention is not limit to the aforementioned embodiment and the accompanying drawings and it should be understood that various changes, substitutions and alterations can be made herein by the skilled in the arts without departing from the sprit and the scope of the present invention as defined by the appended claims.

1. A three dimensional stereoscopic image display apparatus, comprising:
an image display panel portion in which a plurality of left eye image pixels and a plurality of right eye image pixels are alternately disposed;
a first polarizing plate disposed in front of the image display panel portion; and
a second polarizing plate disposed in front of the first polarizing plate,
wherein the first polarizing plate comprises a plurality of first left eye image polarizers which correspond to the plurality of the left eye image pixels and a plurality of first right eye image polarizers which correspond to the plurality of the right eye image pixels, and
wherein the second polarizing plate comprises a second left eye image polarizing portion and a second right eye image polarizing portion.

2. A three dimensional stereoscopic image display apparatus according to claim 1,
wherein the second left eye image polarizing element comprises
a second left eye image transparent polarizer for passing light directed from the first left eye image polarizers to the left eye; and
a second left eye image shielding polarizer for shielding light directed from the first left eye image polarizers to the right eye, and
wherein the second right eye image polarizing portion comprises
a second right eye image shielding polarizer for shielding light directed from the first right eye image polarizers to the left eye; and
a second right eye image transparent polarizer for passing light directed from the first right eye image polarizers to the right eye.

3. A three dimensional stereoscopic image display apparatus according to claim 1,
wherein the first left eye image polarizer and the second left eye image polarizing element have a first polarization angle,
wherein the first right eye image polarizer and the second right eye image polarizing portion have a second polarization angle, and
wherein the phase difference between the first and second polarization angles is 90 degree.

4. A three dimensional stereoscopic image display apparatus according to claim 2,
wherein the first left eye image polarizer, the second left eye image transparent polarizer, and the second right eye image shielding polarizer has a first polarization angle,
wherein the first right eye image polarizer, the second left eye image shielding polarizer, and the second right eye transparent polarizer has a second polarization angle, and
wherein the phase difference between the first and second polarization angles is 90 degree.

5. A three dimensional stereoscopic image display apparatus according to claim 3,
wherein the first polarization angle is 45 degree, and
wherein the first polarization angle is −45 degree.

6. A three dimensional stereoscopic image display apparatus according to claim 4,
wherein the first polarization angle is 45 degree, and
wherein the first polarization angle is 45 degree.

7. A three dimensional stereoscopic image display apparatus according to any one of claims 1 to 6,
wherein the first polarizing plate and the second polarizing plat angle is able to be changed between an active state and an inactive state.

8. A three dimensional stereoscopic image display apparatus according to any one of claims 1 to 6,
wherein the second polarizing plate is formed with a twisted nematic (TN) liquid crystal device.

9. A three dimensional stereoscopic image display apparatus according to any one of claims 1 to 6,
wherein the image display panel portion is constructed with a liquid crystal display panel.

10. A three dimensional stereoscopic image display apparatus according to any one of claims 1 to 6,
wherein the image display panel portion is constructed with a plasma display panel.

11. A goggle non-goggle convertible stereoscopic image display system comprising a three dimensional stereoscopic image display apparatus according to any one of claims 1 to 6,

12. A goggle non-goggle convertible stereoscopic image display system comprising a three dimensional stereoscopic image display apparatus according to any one of claims 7.

13. A goggle non-goggle convertible stereoscopic image display system comprising a three dimensional stereoscopic image display apparatus according to any one of claims 8.

14. A goggle non-goggle convertible stereoscopic image display system comprising a three dimensional stereoscopic image display apparatus according to any one of claims 9.

15. A goggle non-goggle convertible stereoscopic image display system comprising a three dimensional stereoscopic image display apparatus according to any one of claims 10.

16. A three-dimensional two-dimensional convertible stereoscopic image display system comprising a three dimensional stereoscopic image display apparatus according to any one of claims 1 to 6,

17. A three-dimensional two-dimensional convertible stereoscopic image display system comprising a three dimensional stereoscopic image display apparatus according to any one of claims 7.

18. A three-dimensional two-dimensional convertible stereoscopic image display system comprising a three dimensional stereoscopic image display apparatus according to any one of claims 8.

19. A three-dimensional two-dimensional convertible stereoscopic image display system comprising a three dimensional stereoscopic image display apparatus according to any one of claims 9.

20. A three-dimensional two-dimensional convertible stereoscopic image display system comprising a three dimensional stereoscopic image display apparatus according to any one of claims 10.
